(19) United States
(12) Patent Application Publication
(10) Pub. No.: US 2026/0326802 A1
(43) Pub. Date: Oct. 22, 2026

(54) SLIDABLY FLAT-FOLDED CART

(71) Applicant: Zhejiang Pride Leisure Products Co,. Ltd., Jinhua (CN)

(72) Inventors: Benlong SUN, Jinhua (CN); Yubao Zhou, Jinhua (CN)

(21) Appl. No.: 19/651,595

(22) Filed: Apr. 17, 2026

(30) Foreign Application Priority Data
Apr. 17, 2025 (CN) 202520730352.6

(51) Int. Cl. B62B 3/02; B62B 5/06

(52) U.S. Cl. CPC B62B 3/022; B62B 5/065

(57) ABSTRACT

A slidably flat-folded cart includes a frame body, a back frame, and a frame body consisting of left and right side folding frames and a bottom folding frame, where casters are disposed at bottoms of the front frame and the back frame; each of the side folding frames includes one or more X-shaped cross pipes movably hinged in a same plane, an outer upper end is longitudinally and slidably connected to the front frame or the back frame, and an outer lower end is movably riveted to a lower end of the front frame or the back frame; and the bottom folding frame includes a pair of supporting assemblies symmetrically disposed front and back. The cart can be flat-folded and stored quickly. The folded cart occupies a small space after being folded.

### BACKGROUND OF THE INVENTION

### 1. Technical Field The present disclosure belongs to the technical field of carts, and in particular, to a slidably flat-folded cart.

### 2. Description of Related Art

In daily life, carts are mainly used in some places where transportation with motor vehicles is inconvenient. Common cart structures are foldable or unfoldable.

Chinese Patent Publication No. CN219192301U discloses a cart with an anti-collision protection function. In this patent, the size of the cart is fixed, and the cart cannot be folded, so that the size is large, which is adverse to packaging and transportation. Chinese Patent Publication No. CN205469183U discloses a fixed structure of a foldable cart. Although the fixed structure of this cart can be folded, the frame height changes. The height of the cart in the folded state becomes higher compared with the unfolded state, which is also adverse to storage and transportation.

### BRIEF SUMMARY OF THE INVENTION

To overcome the defects in the prior art, an objective of the present disclosure is to provide a slidably flat-folded cart.

To achieve the above objective, the present disclosure adopts the following technical solution: a slidably flat-folded cart includes a frame body, a back frame, and a frame body consisting of left and right side folding frames and a bottom folding frame, where casters are disposed at bottoms of the front frame and the back frame; each of the side folding frames includes one or more X-shaped cross pipes movably hinged in a same plane, an outer upper end is longitudinally and slidably connected to the front frame or the back frame, and an outer lower end is movably riveted to a lower end of the front frame or the back frame; and
the bottom folding frame includes a pair of supporting assemblies symmetrically disposed front and back, where each of the supporting assemblies includes two supporting pipes distributed in a splayed manner, ends, facing a center of the frame body and away from the center of the frame body, of the two supporting pipes are respectively proximal ends and separated ends, the four proximal ends are movably riveted on a same axis through hinge pins, and the four separated ends are movably riveted to left and right sides of the front frame or the back frame, respectively.

Further, the two proximal ends on one of the front side and the back side are provided with end covers, the two proximal ends provided with the end covers are respectively located on left and right sides of the two proximal ends on the other side, and the hinge pins extend through the end covers and the proximal ends to be movably connected.

Further, the bottom folding frame further includes a pair of bottom pipes, and two ends of each of the bottom pipes are respectively connected to inner side surfaces of the two corresponding separated ends.

Further, the slidably flat-folded cart further includes a side frame connecting pipe located below the bottom folding frame, and left and right ends of the side frame connecting pipe are movably riveted to the two side folding frames, respectively.

Further, the side frame connecting pipe includes a square pipe integrally formed and flat pipes located at two ends of the square pipe.

Further, the slidably flat-folded cart further includes two L-shaped connectors, where one end of each of the L-shaped connectors is movably riveted to an end of the side frame connecting pipe, and the other end of each of the L-shaped connectors is movably riveted to the side folding frame.

Further, the side folding frame includes three X-shaped cross pipes, two side frame connecting pipes are disposed, movable riveting parts at lower ends of two adjacent X-shaped cross pipes are lower riveting points, and the other end of each of the L-shaped connectors in each of the side frame connecting pipes is movably riveted to the corresponding lower riveting point.

Further, the front frame or the back frame includes a lower cross pipe and two vertical pipes provided with the casters at bottoms, two ends of the lower cross pipe are respectively connected to lower ends of the two vertical pipes; and each of the vertical pipes is provided with a sliding seat capable of sliding up and down, and the sliding seat is movably riveted to an upper end of the corresponding side folding frame.

Further, the front frame or the back frame further includes an upper cross pipe, and two ends of the upper cross pipe are respectively connected to upper ends of the two vertical pipes.

Further, the lower cross pipe of the front frame is provided with a telescoping handle bar; or the casters on the front frame are universal wheels.

By adopting the technical solution of the present disclosure, the present disclosure has the following beneficial effects: due to the design of the bottom folding frame and the side folding frames, the cart can be flat-folded and stored quickly. The folded cart occupies a small space, and is easy to transport in the production process and easy to carry when users go out; the side folding frames slide up and down through the sliding seats, so that the height of the folded cart is not greater than the height of the cart in the unfolded state, and the height of the folded frame does not change; and the side frame connecting pipes are connected to the left and right side folding frames to support the bottom folding frame, so that the load-bearing capacity of the bottom folding frame is enhanced, and the stability of the cart in use is improved.

### BRIEF DESCRIPTION OF THE SEVERAL VIEWS OF THE DRAWINGS

FIG. 1 is a stereogram I of a first slidably flat-folded cart;

FIG. 2 is a stereogram II of the first slidably flat-folded cart;

FIG. 3 is a stereogram I of a second slidably flat-folded cart; and

FIG. 4 is a stereogram II of the second slidably flat-folded cart.

In the drawings:
1, front frame; 11, vertical pipe; 12, lower cross pipe; 13, upper cross pipe; 2, back frame; 3, side folding frame; 31, X-shaped cross pipe; 32, sliding seat; 33, lower riveting point; 4, bottom folding frame; 41, supporting pipe; 41a, proximal end; 41b, separated end; 42, bottom pipe; 43, end cover; 5, pull rod; 51, handle; 52, telescoping rod; 6, caster; 7, side frame connecting pipe; 71, square pipe; 72, flat pipe; 8, L-shaped connector.

### DETAILED DESCRIPTION OF THE INVENTION

Specific embodiments of specific solutions of the present disclosure are further expounded in conjunction with drawings to make the technical solution clearer and more understandable.

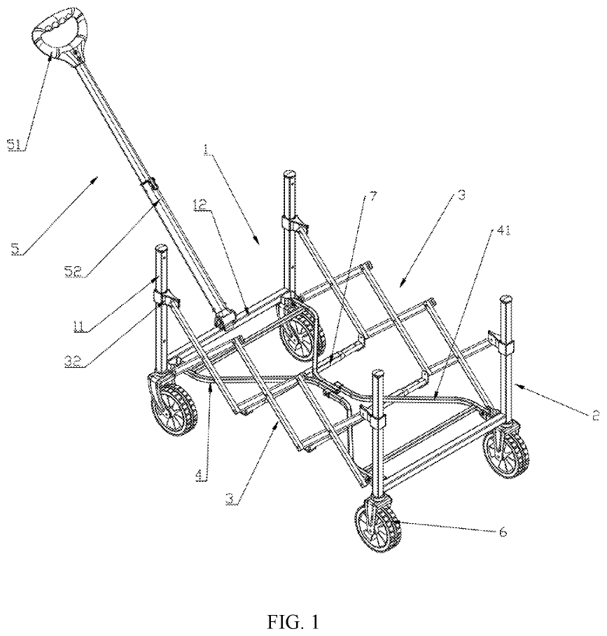

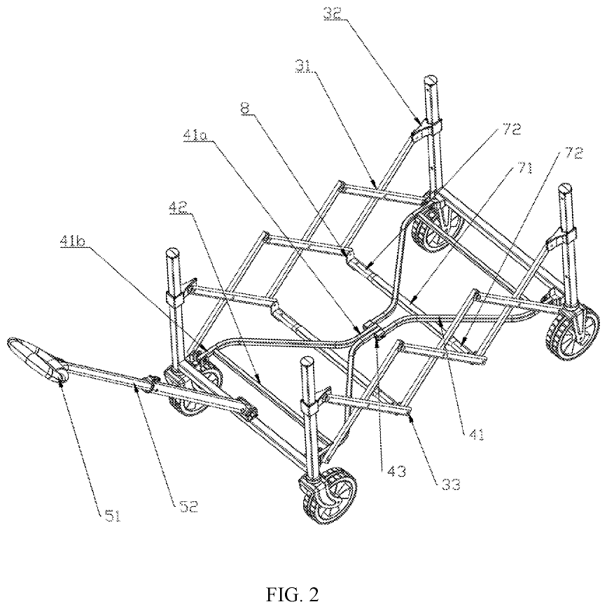

As shown in FIGS. 1-2, a slidably flat-folded cart includes, a frame body 1, a back frame 2, and a frame body consisting of left and right side folding frames 3 and a bottom folding frame 4, where casters 6 are disposed at bottoms of the front frame 1 and the back frame 2; each of the side folding frames 3 includes one or more X-shaped cross pipes 31 movably hinged in a same plane, an outer upper end is longitudinally and slidably connected to the front frame 1 or the back frame 2, and an outer lower end is movably riveted to a lower end of the front frame 1 or the back frame 2; and the bottom folding frame 4 includes a pair of supporting assemblies symmetrically disposed front and back, where each of the supporting assemblies includes two supporting pipes 41 distributed in a splayed manner, ends, facing a center of the frame body and away from the center of the frame body, of the two supporting pipes 41 are respectively proximal ends 41a and separated ends 41b, the four proximal ends 41a are movably riveted on a same axis through hinge pins, and the four separated ends 41b are movably riveted to left and right sides of the front frame 1 or the back frame 2, respectively. Each of the X-shaped cross pipes 31 is formed by two pipes which are movably riveted.

The two proximal ends 41a on one of the front side and the back side are provided with end covers 43, the two proximal ends provided with the end covers 43 are respectively located on left and right sides of the two proximal ends on the other side, and the hinge pins extend through the end covers 43 and the proximal ends to be movably connected. The supporting pipes 41 are preferably square pipes.

The bottom folding frame 4 further includes a pair of bottom pipes 42, and two ends of each of the bottom pipes 42 are respectively connected to inner side surfaces of the two corresponding separated ends 41b. The two supporting pipes 41 distributed in a splayed manner and the bottom pipes 42 are fixedly connected together, and the two proximal ends proximal to the back frame 2 are provided with the end covers 43 on the left and right sides of the two proximal ends proximal to the front frame 1, respectively. The hinge pins extend through the four proximal ends and the two end covers 43 to complete a rotational connection, which achieves independent assembly of the entire bottom folding frame. The two supporting assembles on the front and back sides can be rotationally folded or unfolded relative to the hinge pins.

The cart further includes a side frame connecting pipe 7 located below the bottom folding frame 4, and left and right ends of the side frame connecting pipe 7 are movably riveted to the two side folding frames 4, respectively. When the cart is in the unfolded state, the side frame connecting pipe 7 supports the bottom folding frame 4, so that the stability of the cart carrying people and objects is improved.

The cart further includes two L-shaped connectors 8, where one end of each of the L-shaped connectors 8 is movably riveted to an end of the side frame connecting pipe 7 and the other end of each of the L-shaped connectors 8 is movably riveted to the side folding frame 3.

The side frame connecting pipe 7 includes a square pipe 71 integrally formed and flat pipes 72 located at two ends of the square pipe, and one end of each of the L-shaped connectors 8 is movably riveted to an end of the corresponding flat pipe 72.

In a specific embodiment, the side folding frame 3 includes three X-shaped cross pipes 31 movably connected on a same plane, an upper end of the X-shaped cross pipe 31 on the outer side is movably connected to a sliding seat 32, and a lower end of the X-shaped cross pipe 31 is movably connected to a lower end of the front frame 1 or the back frame 2; and the sliding seat 32 is longitudinally and slidably connected to the front frame 1 or the back frame 2. Two side frame connecting pipes 7 are disposed, movable riveting parts at lower ends of two adjacent X-shaped cross pipes are lower riveting points 33, and the other end of each of the L-shaped connectors 8 in each of the side frame connecting pipes 7 is movably riveted to the corresponding lower riveting point 33.

The front frame 1 and the back frame 2 are same in structure and each include a lower cross pipe 12 and two vertical pipes 11 provided with the casters 6 at bottoms, and two ends of the lower cross pipe 12 are respectively connected to lower ends of the two vertical pipes 11. Through the structure, the front and back side surfaces are directly assembled. Each of the vertical pipes 11 is provided with a sliding seat 32 capable of sliding up and down, and the sliding seat 32 is movably riveted to an upper end of the corresponding side folding frame 3.

The casters of the front frame 1 are universal wheels with brakes, and casters of the back frame 2 are directional wheels.

The lower cross pipe 12 of the front frame 1 is movably provided with a pull rod 5. The pull rod 5 is a telescoping rod 52. A handle 51 is mounted and fixed at a top of the telescoping rod 52. A bottom side of the telescoping rod 52 can be rotationally connected to the lower cross pipe 12 front and back, which specifically means that the bottom is movably riveted to a U-shaped member above the lower cross pipe 12. The whole pull rod 5 is assembled independently.

### Embodiment 2

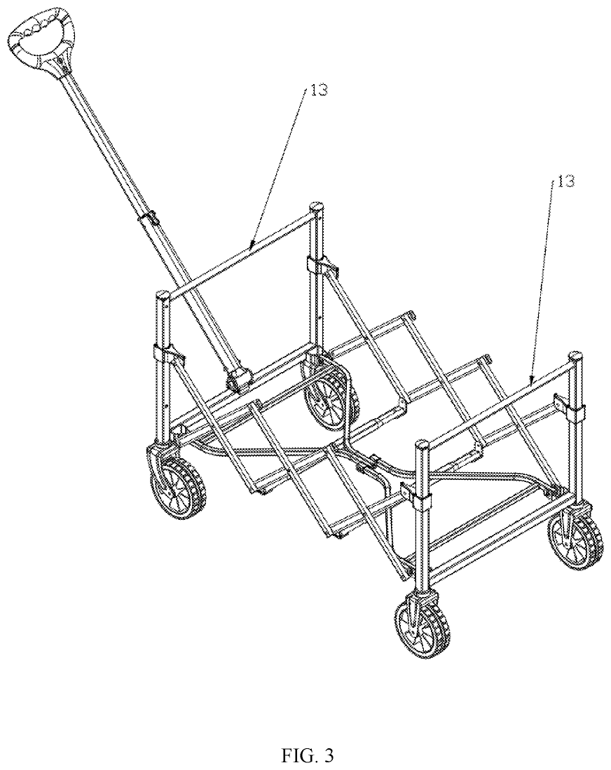

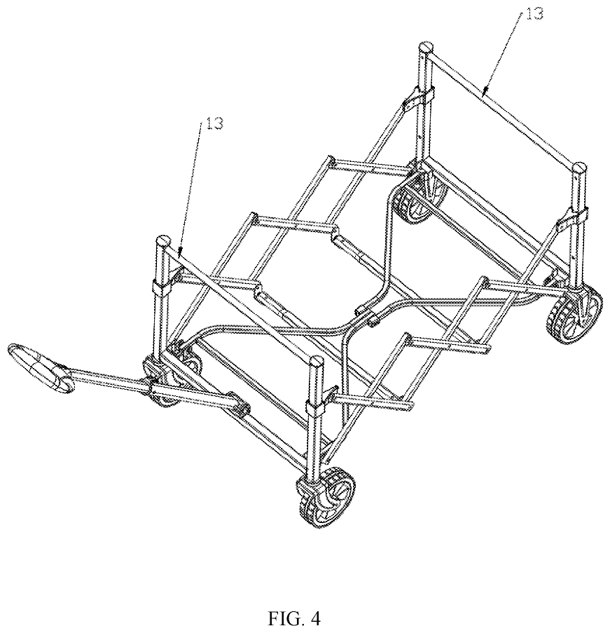

A slidably flat-folded cart as shown in FIGS. 3-4 is different from the cart in Embodiment 1 that the front frame 1 or the back frame 2 in this embodiment further includes an upper cross pipe 13, and two ends of the upper cross pipe 13 are respectively connected to upper ends of the two vertical pipes 11.

It should be noted that the above embodiments are merely preferred ones and applied technical principles of the present disclosure. Those skilled in the art will appreciate that the present disclosure is not limited to the specific embodiments described herein. Those skilled in the art can make various apparent changes, readjustments, and substitutions without departing from the protection scope of the present disclosure. Therefore, although the present disclosure has been described in more detail through the above embodiments, the present disclosure is not limited to the above embodiments. More other equivalent embodiments may further be included without departing from the concept of the present disclosure. The scope of the present disclosure is defined by the appended claims.

What is claimed is:

1. A slidably flat-folded cart, comprising:
a frame body;
a back frame;
wherein the frame body consists of left and right side folding frames and a bottom folding frame;
a plurality of casters are disposed at bottoms of the front frame and the back frame;
each of the side folding frames comprises one or more X-shaped cross pipes movably hinged in a same plane, an outer upper end is longitudinally and slidably connected to the front frame or the back frame, and an outer lower end is movably riveted to a lower end of the front frame or the back frame; and
the bottom folding frame comprises a pair of supporting assemblies symmetrically disposed front and back, wherein each of the supporting assemblies comprises two supporting pipes distributed in a splayed manner;
facing a center of the frame body and away from the center of the frame body are ends of the two supporting pipes, said ends are respectively proximal ends and separated ends; and
the four proximal ends are movably riveted on a same axis through hinge pins, and the four separated ends are movably riveted to left and right sides of the front frame or the back frame, respectively.

2. The slidably flat-folded cart according to claim 1, wherein the two proximal ends on one of the front side and the back side are provided with end covers, the two proximal ends provided with the end covers are respectively located on left and right sides of the two proximal ends on the other side, and the hinge pins extend through the end covers and the proximal ends to be movably connected.

3. The slidably flat-folded cart according to claim 1, wherein the bottom folding frame further comprises a pair of bottom pipes, and two ends of each of the bottom pipes are respectively connected to inner side surfaces of the two corresponding separated ends.

4. The slidably flat-folded cart according to claim 1, further comprising a side frame connecting pipe located below the bottom folding frame, wherein left and right ends of the side frame connecting pipe are movably riveted to the two side folding frames, respectively.

5. The slidably flat-folded cart according to claim 4, wherein the side frame connecting pipe comprises a square pipe integrally formed and flat pipes located at two ends of the square pipe.

6. The slidably flat-folded cart according to claim 4, further comprising two L-shaped connectors, wherein one end of each of the L-shaped connectors is movably riveted to an end of the side frame connecting pipe, and the other end of each of the L-shaped connectors is movably riveted to the side folding frame.

7. The slidably flat-folded cart according to claim 6, wherein the side folding frame comprises three X-shaped cross pipes, two side frame connecting pipes are disposed, movable riveting parts at lower ends of two adjacent said X-shaped cross pipes are lower riveting points, and the other end of each of the L-shaped connectors in each of the side frame connecting pipes is movably riveted to the corresponding lower riveting point.

8. The slidably flat-folded cart according to claim 1, wherein the front frame or the back frame comprises a lower cross pipe and two vertical pipes provided with the casters at bottoms, and two ends of the lower cross pipe are respectively connected to lower ends of the two vertical pipes; and each of the vertical pipes is provided with a sliding seat capable of sliding up and down, and the sliding seat is movably riveted to an upper end of the corresponding side folding frame.

9. The slidably flat-folded cart according to claim 8, wherein the front frame or the back frame further comprises an upper cross pipe, and two ends of the upper cross pipe are respectively connected to upper ends of the two vertical pipes.

10. The slidably flat-folded cart according to claim 8, wherein the lower cross pipe of the front frame is provided with a telescoping handle bar; or the casters on the front frame are universal wheels.

11. The slidably flat-folded cart according to claim 5, further comprising two L-shaped connectors, wherein one end of each of the L-shaped connectors is movably riveted to an end of the side frame connecting pipe, and the other end of each of the L-shaped connectors is movably riveted to the side folding frame.

12. The slidably flat-folded cart according to claim 11, wherein the side folding frame comprises three X-shaped cross pipes, two side frame connecting pipes are disposed, movable riveting parts at lower ends of two adjacent said X-shaped cross pipes are lower riveting points, and the other end of each of the L-shaped connectors in each of the side frame connecting pipes is movably riveted to the corresponding lower riveting point.
